(19) United States
(12) Patent Application Publication
(10) Pub. No.: US 2026/0148110 A1
(43) Pub. Date: May 28, 2026

(54) ENHANCING PHYSICAL REASONING IN VISION-LANGUAGE MODELS USING PROCEDURAL SYNTHETIC DATA GENERATION

(71) Applicant: AUTODESK, INC., San Francisco, CA (US)

(72) Inventors: Mohammadmehdi ATAEI, Toronto (CA); Vahid Balazadeh MERESHT, Toronto (CA); Hyunmin CHEONG, Toronto (CA); Amir Hosein KHAS AHMADI, Toronto (CA)

(21) Appl. No.: 19/402,852

(22) Filed: Nov. 26, 2025

Related U.S. Application Data
(60) Provisional application No. 63/726,125, filed on Nov. 27, 2024.

(51) Int. Cl. G06N 5/04

(52) U.S. Cl. CPC G06N 5/04

(57) ABSTRACT

One embodiment sets forth a technique for fine-tuning a machine learning model to perform physical reasoning. According to some embodiments, the method can include the steps of obtaining simulation annotations that describe interactions among simulated objects within a physics-based environment and one or more question templates, each question template defining a different parameterized reasoning query; generating, based on the simulation annotations and the one or more question templates, a plurality of question-answer pairs that represent physical reasoning examples; formatting the question-answer pairs into natural-language data compatible with the machine learning model; and fine-tuning the machine learning model based on the natural-language data.

### CROSS-REFERENCE TO RELATED APPLICATIONS

This application claims benefit of the United States Provisional Patent Application titled “TECHNIQUES FOR ENHANCING PHYSICAL REASONING IN VISION-LANGUAGE MODELS USING PROCEDURAL SYNTHETIC DATA GENERATION AND SPECIALIZED CONTEXT BUILDER MODULES,” filed November 27, 2024, and having serial number 63/726,125. The subject matter of this related application is hereby incorporated herein by reference.

### BACKGROUND

### Field of the Various Embodiments

The present disclosure relates generally to physics simulations, computer science, artificial intelligence, and complex software applications, and, more specifically, enhancing physical reasoning in vision-language models using procedural synthetic data generation and specialized context builder modules.

### DESCRIPTION OF THE RELATED ART

Physical reasoning constitutes a fundamental aspect of human cognition that enables interpretation of object behaviors, prediction of physical interactions, and understanding of causal relationships in dynamic environments. Physical reasoning encompasses the ability to assess spatial relationships between objects, predict future states of physical systems, and understand causal relationships between physical interactions. Although intuitive to humans, physical reasoning presents a significant challenge for automated systems, including artificial intelligence systems. Accurate physical reasoning is essential for any application where an artificial intelligence system interacts with the physical world. Such applications include robotics, automated vehicles, and mechanical system design.

Recent breakthroughs with transformer architecture machine learning models have enabled the processing of physical scenes from images and videos. Conventional vision-language models (VLMs) represent large machine learning models capable of understanding both visual and textual information simultaneously through a combination of image and text encoders. VLMs are trained on large-scale datasets comprising images with corresponding captions or videos consisting of multiple image frames with corresponding scene descriptions. VLMs excel at descriptive tasks such as scene descriptions and object identification, which provide high-level descriptions of properties associated with image or video content.

One technical drawback of conventional vision-language models involves the challenges associated with fine-tuning existing models for physical reasoning tasks. Fine-tuning existing VLM models is challenging for multiple reasons. Existing datasets for training VLMs consist primarily of image captions and video scene descriptions. Therefore, VLM models trained on such datasets excel in generating captions and descriptions. New datasets would need to be generated to fine-tune models for physical reasoning tasks that require detailed descriptions of scenes from simulations. Such descriptions would precisely describe the positions and interactions of all objects in the scene. Additional, detailed scene data must be presented in a natural language format acceptable to VLMs. Generating such a dataset presents a technical challenge.

Another technical drawback of conventional vision-language models involves limited capability with complex physical reasoning tasks. Despite strong capabilities with descriptive tasks, VLMs encounter difficulties with more complex physical reasoning tasks such as object stability, collision predictions, and causal effects that require reasoning beyond mere observation of physical features. In some cases, VLMs encounter difficulties in accurately describing presented scenes in detail beyond a high-level description.

As the foregoing illustrates, what is needed in the art are more effective techniques for training vision -language models for physical reasoning tasks.

### SUMMARY

One embodiment sets forth a technique for fine-tuning a machine learning model to perform physical reasoning. According to some embodiments, the method can include the steps of obtaining simulation annotations that describe interactions among simulated objects within a physics-based environment and one or more question templates, each question template defining a different parameterized reasoning query; generating, based on the simulation annotations and the one or more question templates, a plurality of question-answer pairs that represent physical reasoning examples; formatting the question-answer pairs into natural-language data compatible with the machine learning model; and fine-tuning the machine learning model based on the natural-language data.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques over the prior art is that the disclosed techniques provide a data generation procedure that generates training datasets for physical reasoning tasks. The disclosed techniques use physics simulation environments to generate synthetic scenes along with precise natural language annotations of object positions and velocities. Extraction of such elements is not possible from real-world videos. Such physical reasoning datasets are useful for fine-tuning existing vision-language models to achieve better performance on physical reasoning tasks.

Another technical advantage of the disclosed techniques over the prior art is that the disclosed techniques enable accurate physical reasoning in vision-language models by fine-tuning vision-language models for physical reasoning tasks. Vision-language models fine-tuned using specialized physical reasoning data are better-equipped to perform challenging physical reasoning tasks, whereas conventionally available vision-language models struggle to perform such tasks.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 is a more detailed illustration of the machine learning server illustrated in FIG. 1, according to various embodiments.

FIG. 3 is a conceptual illustration of an architecture and an informational flow that can be implemented by the question-answer generator of FIG. 1, according to various embodiments.

FIG. 4 is a conceptual illustration of an architecture and an informational flow that can be implemented by the model trainer of FIG. 1, according to various embodiments

FIG. 5 illustrates a method for generating a question-answer fine-tuning training dataset, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

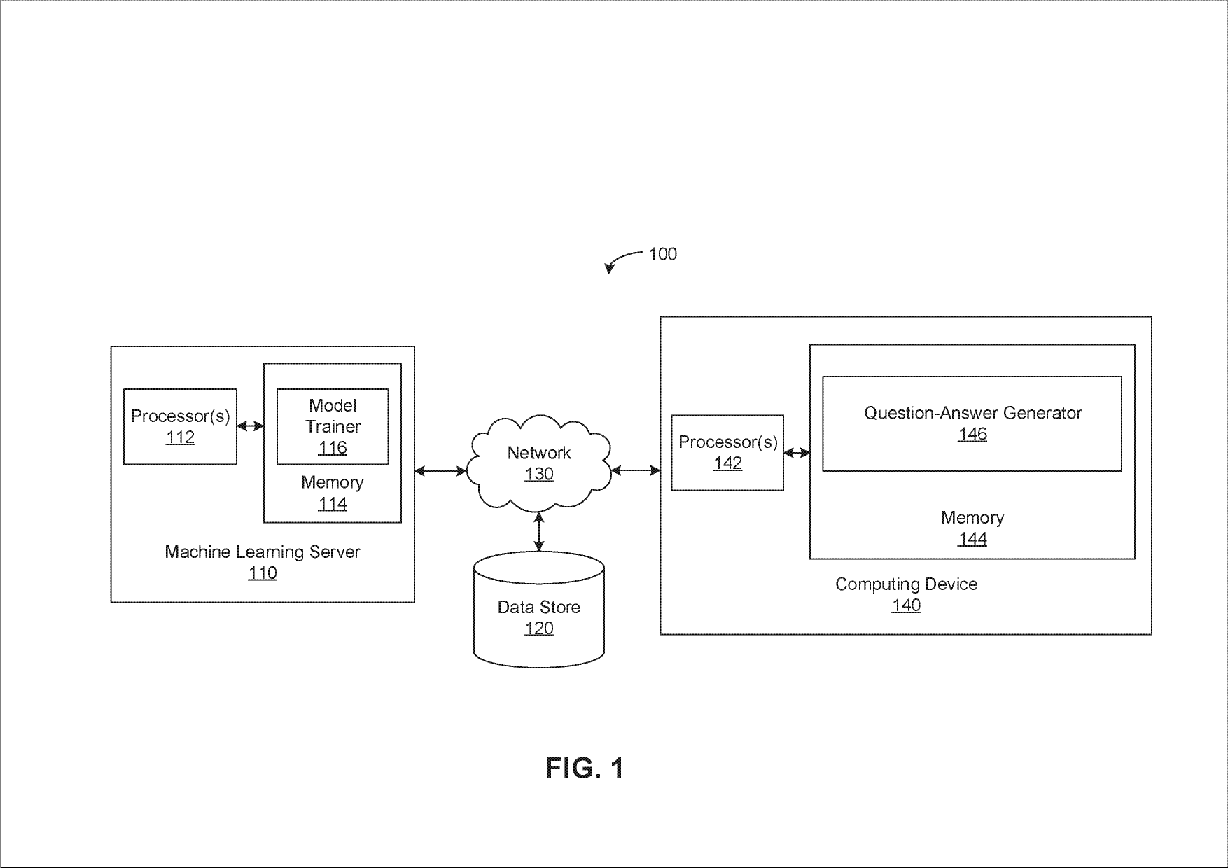

FIG. 1 illustrates a block diagram of a computer-based system 100 configured to implement one or more aspects of the various embodiments. As shown, the system 100 includes, without limitation, a machine learning server 110, a data store 120, and a computing device 140 in communication over a network 130. The network 130 can be a wide area network (WAN) such as the internet, a local area network (LAN), a cellular network, and/or any other suitable network.

As also shown, a model trainer 116 executes on one or more processors 112 of the machine learning server 110 and is stored in a system memory 114 of the machine learning server 110. The one or more processors 112 receive user input from input devices, such as a keyboard or a mouse. In operation, the one or more processors 112 may include one or more primary processors of the machine learning server 110, which control and coordinate operations of other system components. In particular, the processor(s) 112 can issue commands that control the operation of one or more graphics processing units (GPUs) (not shown) and/or other parallel processing circuitry, such as parallel processing units or deep learning accelerators, that incorporate circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or flash ROM), or any suitable combination of the foregoing. In some embodiments, a storage (not shown) can supplement or replace the system memory 114. The storage can include any number and type of external memories accessible to the processor 112 and/or the GPU. For example, and without limitation, the storage can include a secure digital card, an external flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment. Such an environment can be a public, private, or a hybrid cloud system.

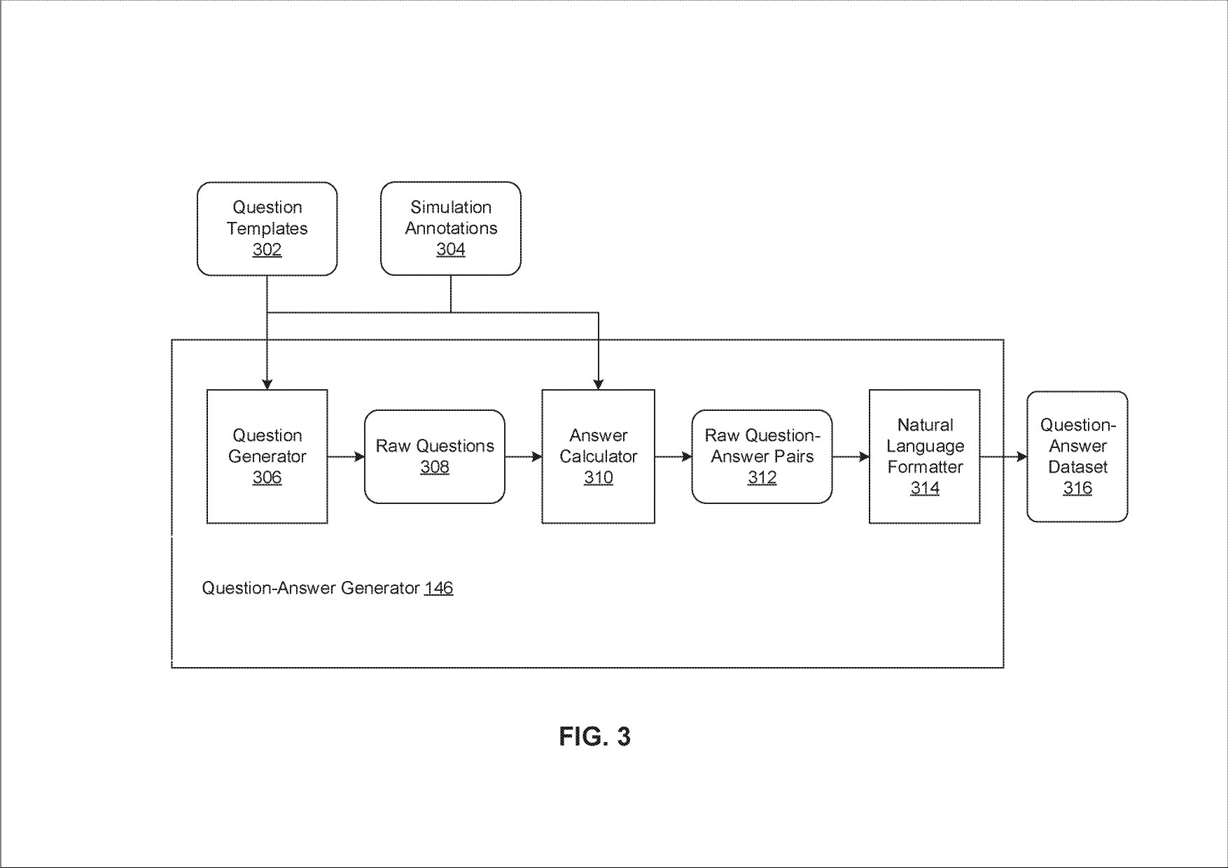

In some embodiments, the model trainer 116 is configured to train one or more machine learning models, including a fine-tuned VLM model 406. Techniques that the model trainer 116 can use to train the machine learning model(s) are discussed in greater detail below in conjunction with FIGS. 3-5. Training data and/or trained (or deployed) machine learning models can be stored in the data store 120. In some embodiments, the data store 120 can include any storage device or devices, such as fixed disc drives, flash drives, optical storage, network attached storage (NAS), and/or a storage area network (SAN). Although shown as accessible over the network 130, in at least one embodiment, the machine learning server 110 can include the data store 120.

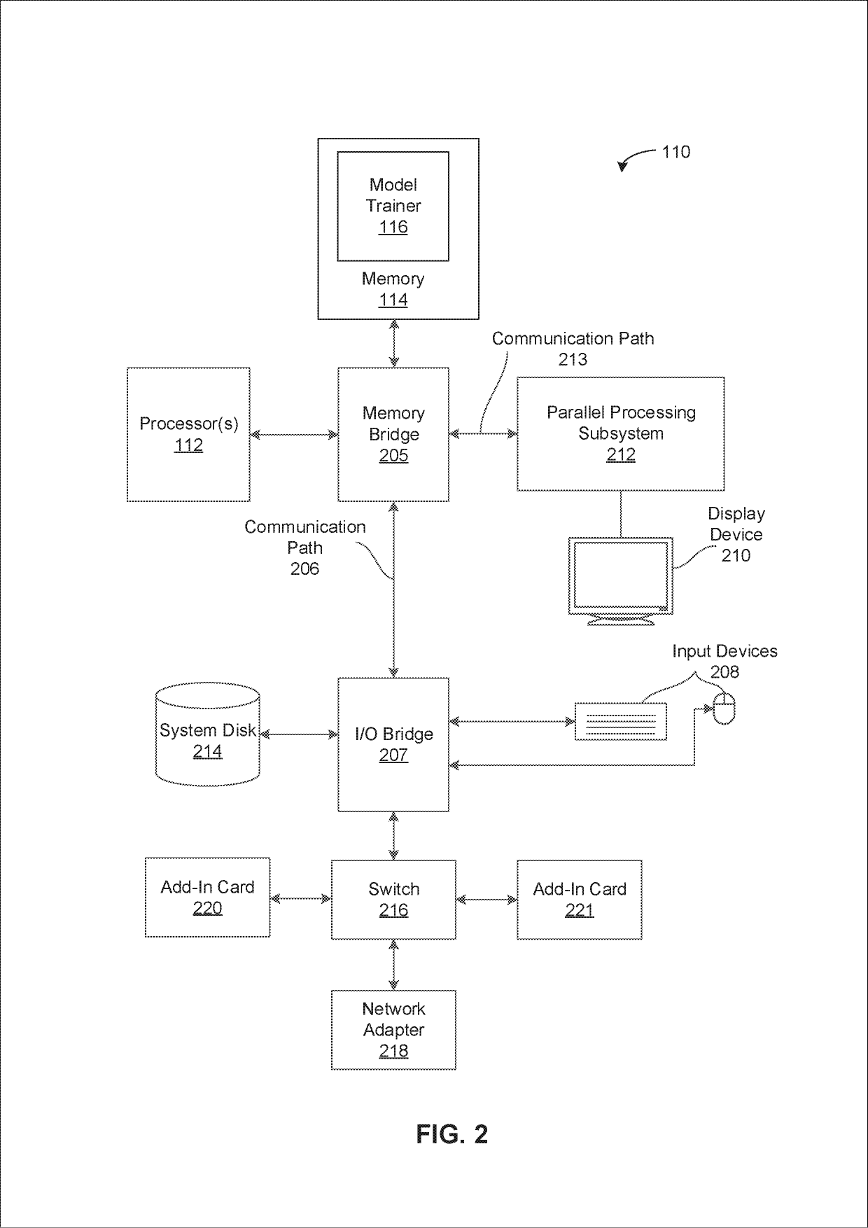

FIG. 2 is a block diagram illustrating the machine learning server 110 of FIG. 1 in greater detail, according to various embodiments. Machine learning server 110 may be any type of computing system, including, without limitation, a server machine, a server platform, a desktop machine, a laptop machine, a handheld/mobile device, a digital kiosk, or a wearable device. In some embodiments, machine learning server 110 is a server machine operating in a data center or a cloud computing environment that provides scalable computing resources as a service over a network.

In various embodiments, machine learning server 110 includes, without limitation, the processor(s) 112 and the memory(IES) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, machine learning server 110 may be a server machine in a cloud computing environment. In such embodiments, machine learning server 110 may not include input devices 208 but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-rom), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a northbridge chip, and I/O bridge 207 may be a southbridge chip. In addition, communication paths 206 and 213, as well as other communication paths within machine learning server 110, may be implemented using any technically suitable protocols, including, without limitation, AGP (accelerated graphics port), hypertransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212. In various embodiments, the parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations.

In various embodiments, parallel processing subsystem 212 may be integrated with one or more of the other elements of FIG. 2 to form a single system. For example, parallel processing subsystem 212 may be integrated with processor 112 and other connection circuitry on a single chip to form a system on a chip (SoC).

System memory 114 includes at least one device driver configured to manage the processing operations of the one or more PPUs within parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI express link, in which dedicated lanes are allocated to each PPU. Other communication paths may also be used. The PPU advantageously implements a highly parallel processing architecture, and the PPU may be provided with any amount of local parallel processing memory.

It will be appreciated that the system shown herein is illustrative and that variations and modifications are possible. The connection topology, including the number and arrangement of bridges or the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In some embodiments, one or more components shown in FIG. 2 may not be present. For example, switch 216 could be eliminated, and network adapter 218 and add-in cards 220, 221 would connect directly to I/O bridge 207. Lastly, in some embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (VPU(s)) that renders graphics on a virtual machine(s) (VM(s)) executing on a server machine(s) whose GPU(s) and other physical resources are shared across one or more VMs.

### Data Generation

FIG. 3 provides a detailed illustration of the question-answer generator 146 described in conjunction with FIG. 1, according to various embodiments. As shown in FIG. 3, the question-answer generator 146 includes a question generator 306, an answer calculator 310, and a natural language formatter 314. The question-answer generator 146 receives question templates 302 and simulation annotations 304 as inputs and generates the question-answer dataset 316 as output.

The question templates 302 consist of pre-defined template strings that specify the structure of questions to be generated for physical reasoning tasks. The question templates 302 include placeholders for scene-specific values that are populated during question generation. For example, in some embodiments, the question templates 302 include templates such as “What is the color of the object at position [PLACEHOLDER]?” or “What shape is the object above [PLACEHOLDER]?”. The question templates 302 span multiple question categories, including descriptive questions that query observable properties of the scene, stability questions that assess whether objects will remain stationary, spatial relationship questions that query the relative position of objects, and causal questions that query how scenes are likely to evolve given various object positions and movements. In some embodiments, the question templates 302 include the relevant logic required to calculate the question’s answer when provided with a corresponding simulation annotation 304. For example, in some embodiments, for the question “What is the color of the object at position [PLACEHOLDER]?” additional logic would contain instructions to query the object at the correct position and select the color property.

The simulation annotations 304 consist of structured data output by a physics simulation environment that executed a simulation of a physical scene. The simulation annotations 304 include object identifiers, object properties, spatial information, as well as object positions over multiple time intervals. For example, in some embodiments, the simulation annotations 304 include the shape and color of various objects, as well as the positions and velocities of the objects at various points in time in the simulation. The simulation annotations 304 are generated by physical simulation software that realistically simulates the motions and interactions of objects of various types in a scene. The simulation annotations 304 are formatted as structured data that can be parsed by the question generator 306 and the answer calculator 310, such as JSON or XML.

The question generator 306 receives the question templates 302 and the simulation annotations 304 as inputs and generates the raw questions 308 as output. The question generator 306 parses the question templates 302 to populate the placeholder values with valid values for the scenes to which the question template 302 is applicable, according to the values provided in the simulation annotations 304. For example, if the scene contains multiple objects, the question generator 306 will populate the question template 302 “What is the color of the object at position [PLACEHOLDER]?” with valid positions in the scene, such as front, back, second from the back, etc. The question generator 306 populates each question template 302 with all possible valid placeholder values for each simulation annotation 304. The resulting populated questions, along with the corresponding answer-generating logic from the question template 302, are returned as raw questions 308.

The answer calculator 310 receives the raw questions 308 and the simulation annotations 304 as input and generates the raw question-answer pairs 312 as output. The answer calculator 310 applies the answer-generating logic from the raw questions 308 to the corresponding simulation annotation 304 to extract the relevant question answer. For example, in the case of the question “What is the color of the object at the position rear?” the answer calculator 310 queries for the furthest back object and extracts the color value of the furthest back object. In the case of stability questions, the answer calculator 310 may extract the initial and final positions of all objects in the scene and determine if the objects have moved significantly over the course of the simulation. The answer calculator 310 pairs each question from the raw questions 308 with the corresponding calculated answer as raw question-answer pairs 312.

The natural language formatter 314 receives the raw question-answer pairs 312 as input and generates the question-answer dataset 316 as output. The natural language formatter 314 converts the raw question-answer pairs 312 into valid natural language strings compatible with vision-language models. For example, the natural language formatter 314 may convert Boolean answers into full sentences, such as “The tower will remain stationary,” in some embodiments. In other embodiments, the natural language formatter 314 will convert a simple answer into valid sentences, such as “The object in the rear position is purple.” Additionally, in some embodiments, the natural language formatter 314 also uses a language model to perform rewording of the question-answer pairs, to provide variance to the vision-language model to avoid memorizing exact question formats. The natural language formatter 314 outputs the formatted question-answer pairs as the question-answer dataset 316.

### Fine-tuning with Physical Question-Answer Pairs

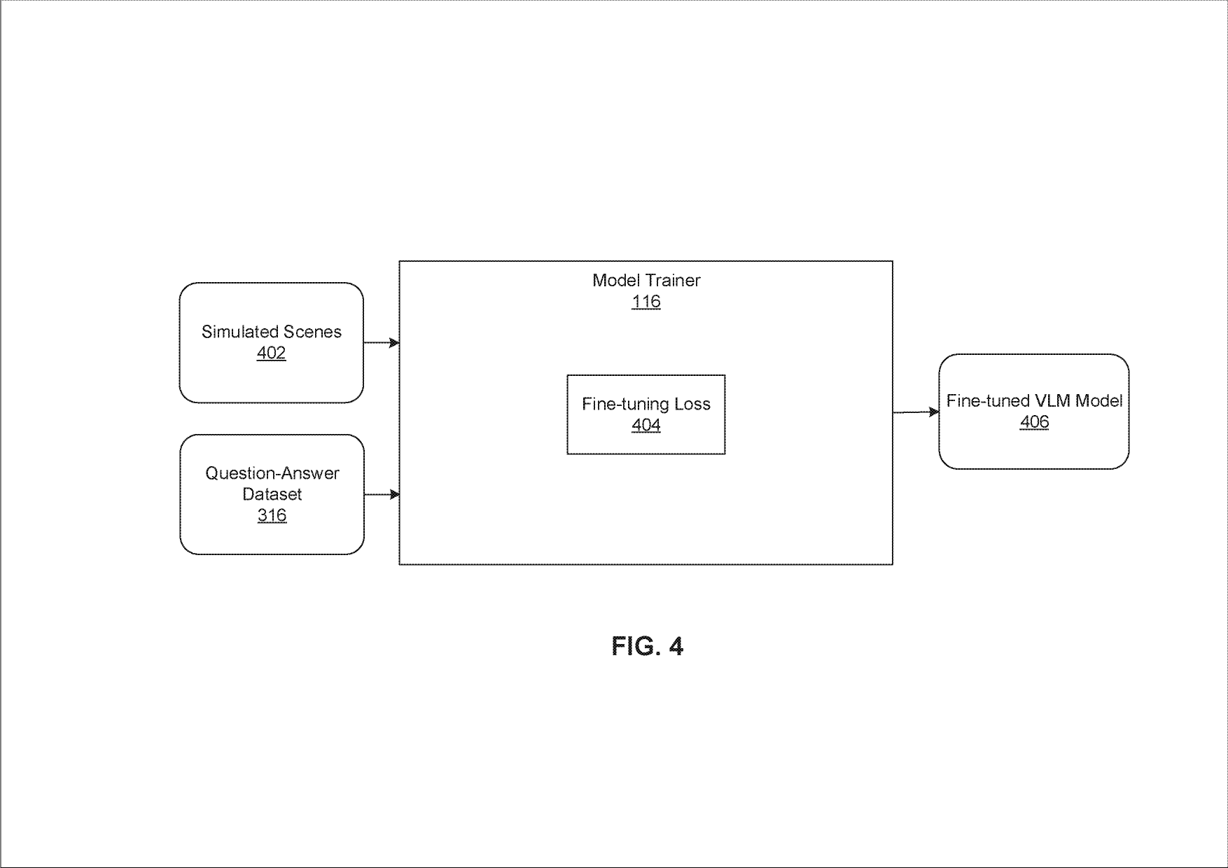

FIG. 4 provides a detailed illustration of a vision-language model fine-tuning system described in conjunction with FIG. 1, according to various embodiments. As shown in FIG. 4, the vision-language model fine-tuning system includes a model trainer 116 and a fine-tuning loss 404. The model trainer 116 receives simulated scenes 402 and the question-answer dataset 316 as inputs and generates the fine-tuned VLM model 406 as output.

The simulated scenes 402 consist of visual data generated by a physics simulation environment, including images or videos shown in physical scenes of object interactions. Each visual data instance in the simulated scenes 402 corresponds to one or more training examples in the question-answer dataset 316. The question-answer dataset 316 consists of training examples of question-answer pairs corresponding to the associated simulated scene 402. Each question-answer pair in the question-answer dataset 316 contains a natural language question and a natural language answer corresponding to the simulated events in the associated simulated scene 402. In some embodiments, the question-answer dataset 316 is generated by the question-answer generator 146 described in conjunction with FIG. 3, according to various embodiments.

The model trainer 116 receives the simulated scenes 402 and the question-answer dataset 316 as inputs and performs a fine-tuning procedure to optimize a pre-trained vision-language model for physical reasoning tasks. The model trainer 116 provides a simulated scene 402 and the question from the question-answer dataset 316 as input to the model and compares the generated predictions against the answer from the question-answer dataset 316. The fine-tuning loss 404 quantifies the difference between the predicted and correct answers and updates the parameters of the fine-tuning model weights to minimize the fine-tuning loss 404 using backpropagation. The training procedure continues until the convergence criteria have been met, at which point the model trainer 116 returns the fine-tuned VLM model 406.

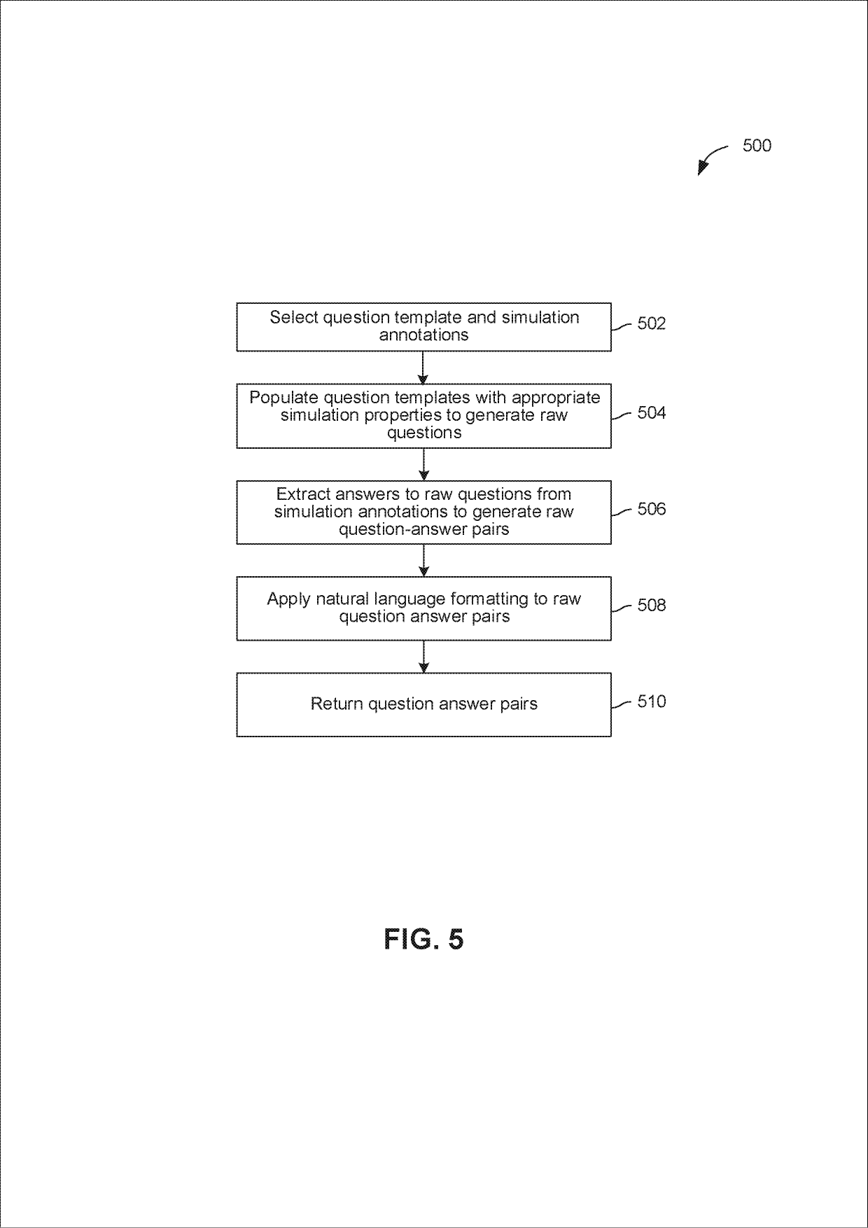

FIG. 5 sets forth a flow diagram of method steps for generating question-answer training data from physics simulation annotations, according to various embodiments. Although the method steps are described in conjunction with the systems of FIGS. 1-4, persons skilled in the art will understand that any system configured to perform the method steps in any order falls within the scope of the present disclosure.

As shown, method 500 begins at step 502, where the question-answer generator 146 selects question templates 302 and receives simulation annotations 304. The question templates 302 define the structure of questions to be generated and include placeholders for scene-specific values. The simulation annotations 304 include structured data output by a physics simulation environment and include object properties as well as spatial and temporal relationships between objects. In some embodiments, the question templates 302 also include logic by which the answer to the question can be extracted from the simulation annotations 304.

At step 504, the question generator 306 populates the question templates 302 with simulation properties to generate raw questions 308. The question generator 306 parses the simulation annotations 304 to extract scene-specific values. The question generator 306 populates each question template 302 with all valid values for each simulation annotation 304 to produce the raw questions 308.

At step 506, the answer calculator 310 extracts answers to the raw questions 308 from the simulation annotations 304 to generate raw question-answer pairs 312. The answer calculator 310 uses the associated logic of the raw questions 308 to extract the correct answer from the simulation annotations 304. The answers are combined with the raw questions 308 and returned as the raw question-answer pairs 312.

At step 508, the natural language formatter 314 applies natural language formatting to the raw question-answer pairs 312. The natural language formatter 314 converts answer values into valid natural language strings compatible with vision-language models. In some embodiments, the natural language formatter 314 performs minor rewordings of the raw question-answer pairs 312 to create more variance in the training data.

At step 510, the question-answer generator 146 returns the question-answer dataset 316. The question-answer dataset 316 is a training dataset for fine-tuning vision-language models on physical reasoning questions based on question-answer pairs from simulated scenes.

It should be appreciated that, while the foregoing embodiments primarily describe the use of physics-based simulation environments and simulated objects to generate structured annotations for downstream question-answer generation, the disclosed techniques are not limited to purely simulated data sources. In some implementations, the annotations may instead be derived from, or supplemented with, real-world captured scenes that include rich object-level metadata, such as tracked positions, interaction events, segmentation masks, depth information, or other perception-based attributes obtained through sensor systems, computer-vision pipelines, or hybrid sensor-simulation workflows. In such cases, the same question templates, reasoning-logic operations, and natural-language formatting processes described herein may be applied to annotations originating from real environments, simulated environments, or any combination thereof. Accordingly, the methods and systems disclosed are equally applicable to training or fine-tuning machine learning models using annotations that describe interactions among objects regardless of whether such annotations arise from simulation, real-world capture, or mixed reality data collection techniques.

In sum, the disclosed techniques are directed toward the implementation of enhanced physical reasoning capabilities in vision-language models through simulation-based training data generation and modular inference architectures. More specifically, in some embodiments, the disclosed techniques include the generation of training data that comprises images and/or videos of physical scenes in conjunction with detailed annotations of object positions and velocities through simulation tools. A data generation module receives the simulation annotations and converts the simulation annotations into question-answer pairs about the provided scene according to various question templates. The question-answer pairs, along with the simulated scenes, can then be used to fine-tune a vision-language model to perform physical reasoning tasks.

One technical advantage of the disclosed techniques over the prior art is that the disclosed techniques provide a data generation procedure that generates training datasets for physical reasoning tasks. The disclosed techniques use physics simulation environments to generate synthetic scenes along with precise natural language annotations of object positions and velocities. Extraction of such elements is not possible from real-world videos. Such physical reasoning datasets are useful for fine-tuning existing vision-language models to achieve better performance on physical reasoning tasks.

Another technical advantage of the disclosed techniques over the prior art is that the disclosed techniques enable accurate physical reasoning in vision-language models by fine-tuning vision-language models for physical reasoning tasks. Vision -language models fine-tuned using specialized physical reasoning data are better-equipped to perform challenging physical reasoning tasks, whereas conventionally available vision-language models struggle to perform such tasks.

1. In some embodiments, a method for fine-tuning a machine learning model to perform physical reasoning comprises: obtaining simulation annotations that describe interactions among simulated objects within a physics-based environment and one or more question templates, each question template defining a different parameterized reasoning query; generating, based on the simulation annotations and the one or more question templates, a plurality of question-answer pairs that represent physical reasoning examples; formatting the question-answer pairs into natural-language data compatible with the machine learning model; and fine-tuning the machine learning model based on the natural-language data.

2. The computer-implemented method of clause 1, wherein the simulation annotations comprise structured data generated by executing the physics-based environment, wherein the structured data includes at least one of object identifiers, positions, velocities, or interactions associated with the simulated objects.

3. The computer-implemented method of any of clauses 1-2, wherein each parameterized reasoning query includes at least one of descriptive reasoning, spatial reasoning, stability reasoning, or causal reasoning.

4. The computer-implemented method of any of clauses 1-3, wherein generating the plurality of question-answer pairs comprises substituting scene-specific values from the simulation annotations into placeholder fields of the one or more question templates.

5. The computer-implemented method of any of clauses 1-4, wherein generating the plurality of question-answer pairs comprises calculating each question-answer pair by applying logic associated with a corresponding question template to a relevant subset of the simulation annotations.

6. The computer-implemented method of any of clauses 1-5, wherein formatting the plurality of question-answer pairs comprises generating complete natural-language sentences that express, for each question-answer pair included in the plurality of question-answer pairs, a question portion and a corresponding answer portion.

7. The computer-implemented method of any of clauses 1-6, wherein formatting the plurality of question-answer pairs further comprises generating reworded variants of at least one question-answer pair included in the plurality of question-answer pairs to increase an overall diversity metric of the natural-language data.

8. The computer-implemented method of any of clauses 1-7, wherein fine-tuning the machine learning model comprises training a pre-trained vision-language model using the natural-language data and adjusting model parameters of the pre-trained vision-language model to minimize a loss function.

9. The computer-implemented method of any of clauses 1-8, further comprising associating the simulation annotations with visual data representing simulated scenes and temporally aligning the natural-language data and the simulation annotations with the visual data.

10. The computer-implemented method of any of clauses 1-9, wherein fine-tuning the machine learning model comprises adjusting model parameters of the machine learning model based on the natural-language data until performance on physical-reasoning validation tasks involving at least one of spatial inference, dynamic inference, or causal inference satisfies a predefined accuracy criterion.

11. In some embodiments, one or more non-transitory computer readable media store instructions that, when executed by one or more processors, cause the one or more processors to fine-tune a machine learning model to perform physical reasoning, by performing the operations of: obtaining simulation annotations that describe interactions among simulated objects within a physics-based environment and one or more question templates, each question template defining a different parameterized reasoning query; generating, based on the simulation annotations and the one or more question templates, a plurality of question-answer pairs that represent physical reasoning examples; formatting the question-answer pairs into natural-language data compatible with the machine learning model; and fine-tuning the machine learning model based on the natural-language data.

12. The one or more non-transitory computer readable media of clause 11, wherein the simulation annotations comprise structured data generated by executing the physics-based environment, wherein the structured data includes at least one of object identifiers, positions, velocities, or interactions associated with the simulated objects.

13. The one or more non-transitory computer readable media of any of clauses 11-12, wherein each parameterized reasoning query includes at least one of descriptive reasoning, spatial reasoning, stability reasoning, or causal reasoning.

14. The one or more non-transitory computer readable media of any of clauses 11-13, wherein generating the plurality of question-answer pairs comprises substituting scene-specific values from the simulation annotations into placeholder fields of the one or more question templates.

15. The one or more non-transitory computer readable media of any of clauses 11-14, wherein generating the plurality of question-answer pairs comprises calculating each question-answer pair by applying logic associated with a corresponding question template to a relevant subset of the simulation annotations.

16. The one or more non-transitory computer readable media of any of clauses 11-15, wherein formatting the plurality of question-answer pairs comprises generating complete natural-language sentences that express, for each question-answer pair included in the plurality of question-answer pairs, a question portion and a corresponding answer portion.

17. The one or more non-transitory computer readable media of any of clauses 11-16, wherein formatting the plurality of question-answer pairs further comprises generating reworded variants of at least one question-answer pair included in the plurality of question-answer pairs to increase an overall diversity metric of the natural-language data.

18. The one or more non-transitory computer readable media of any of clauses 11-17, wherein fine-tuning the machine learning model comprises training a pre-trained vision-language model using the natural-language data and adjusting model parameters of the pre-trained vision-language model to minimize a loss function.

19. The one or more non-transitory computer readable media of any of clauses 11-18, wherein the operations further comprise associating the simulation annotations with visual data representing simulated scenes and temporally aligning the natural-language data and the simulation annotations with the visual data.

20. In some embodiments, a computer system comprises one or more memories that include instructions, and one or more processors that are coupled to the one or more memories and that, when executing the instructions, are configured to fine-tune a machine learning model to perform physical reasoning, by performing the operations of: obtaining simulation annotations that describe interactions among simulated objects within a physics-based environment and one or more question templates, each question template defining a different parameterized reasoning query; generating, based on the simulation annotations and the one or more question templates, a plurality of question-answer pairs that represent physical reasoning examples; formatting the question-answer pairs into natural-language data compatible with the machine learning model, and fine-tuning the machine learning model based on the natural-language data.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A method for fine-tuning a machine learning model to perform physical reasoning, the method comprising:
obtaining simulation annotations that describe interactions among simulated objects within a physics-based environment and one or more question templates, each question template defining a different parameterized reasoning query;
generating, based on the simulation annotations and the one or more question templates, a plurality of question-answer pairs that represent physical reasoning examples;
formatting the question-answer pairs into natural-language data compatible with the machine learning model; and
fine-tuning the machine learning model based on the natural-language data.

2. The computer-implemented method of claim 1, wherein the simulation annotations comprise structured data generated by executing the physics-based environment, wherein the structured data includes at least one of object identifiers, positions, velocities, or interactions associated with the simulated objects.

3. The computer-implemented method of claim 1, wherein each parameterized reasoning query includes at least one of descriptive reasoning, spatial reasoning, stability reasoning, or causal reasoning.

4. The computer-implemented method of claim 1, wherein generating the plurality of question-answer pairs comprises substituting scene-specific values from the simulation annotations into placeholder fields of the one or more question templates.

5. The computer-implemented method of claim 1, wherein generating the plurality of question-answer pairs comprises calculating each question-answer pair by applying logic associated with a corresponding question template to a relevant subset of the simulation annotations.

6. The computer-implemented method of claim 1, wherein formatting the plurality of question-answer pairs comprises generating complete natural-language sentences that express, for each question-answer pair included in the plurality of question-answer pairs, a question portion and a corresponding answer portion.

7. The computer-implemented method of claim 1, wherein formatting the plurality of question-answer pairs further comprises generating reworded variants of at least one question-answer pair included in the plurality of question-answer pairs to increase an overall diversity metric of the natural-language data.

8. The computer-implemented method of claim 1, wherein fine-tuning the machine learning model comprises training a pre-trained vision-language model using the natural-language data and adjusting model parameters of the pre-trained vision-language model to minimize a loss function.

9. The computer-implemented method of claim 1, further comprising associating the simulation annotations with visual data representing simulated scenes and temporally aligning the natural-language data and the simulation annotations with the visual data.

10. The computer-implemented method of claim 1, wherein fine-tuning the machine learning model comprises adjusting model parameters of the machine learning model based on the natural-language data until performance on physical-reasoning validation tasks involving at least one of spatial inference, dynamic inference, or causal inference satisfies a predefined accuracy criterion.

11. One or more non-transitory computer readable media storing instructions that, when executed by one or more processors, cause the one or more processors to fine-tune a machine learning model to perform physical reasoning, by performing the operations of:
obtaining simulation annotations that describe interactions among simulated objects within a physics-based environment and one or more question templates, each question template defining a different parameterized reasoning query;
generating, based on the simulation annotations and the one or more question templates, a plurality of question-answer pairs that represent physical reasoning examples;
formatting the question-answer pairs into natural-language data compatible with the machine learning model; and
fine-tuning the machine learning model based on the natural-language data.

12. The one or more non-transitory computer readable media of claim 11, wherein the simulation annotations comprise structured data generated by executing the physics-based environment, wherein the structured data includes at least one of object identifiers, positions, velocities, or interactions associated with the simulated objects.

13. The one or more non-transitory computer readable media of claim 11, wherein each parameterized reasoning query includes at least one of descriptive reasoning, spatial reasoning, stability reasoning, or causal reasoning.

14. The one or more non-transitory computer readable media of claim 11, wherein generating the plurality of question-answer pairs comprises substituting scene-specific values from the simulation annotations into placeholder fields of the one or more question templates.

15. The one or more non-transitory computer readable media of claim 11, wherein generating the plurality of question-answer pairs comprises calculating each question-answer pair by applying logic associated with a corresponding question template to a relevant subset of the simulation annotations.

16. The one or more non-transitory computer readable media of claim 11, wherein formatting the plurality of question-answer pairs comprises generating complete natural-language sentences that express, for each question-answer pair included in the plurality of question-answer pairs, a question portion and a corresponding answer portion.

17. The one or more non-transitory computer readable media of claim 11, wherein formatting the plurality of question-answer pairs further comprises generating reworded variants of at least one question-answer pair included in the plurality of question-answer pairs to increase an overall diversity metric of the natural-language data.

18. The one or more non-transitory computer readable media of claim 11, wherein fine-tuning the machine learning model comprises training a pre-trained vision-language model using the natural-language data and adjusting model parameters of the pre-trained vision-language model to minimize a loss function.

19. The one or more non-transitory computer readable media of claim 11, wherein the operations further comprise associating the simulation annotations with visual data representing simulated scenes and temporally aligning the natural-language data and the simulation annotations with the visual data.

20. A computer system, comprising:
one or more memories that include instructions; and
one or more processors that are coupled to the one or more memories and, when executing the instructions, are configured to fine-tune a machine learning model to perform physical reasoning, by performing the operations of:
obtaining simulation annotations that describe interactions among simulated objects within a physics-based environment and one or more question templates, each question template defining a different parameterized reasoning query;
generating, based on the simulation annotations and the one or more question templates, a plurality of question-answer pairs that represent physical reasoning examples;
formatting the question-answer pairs into natural-language data compatible with the machine learning model; and
fine-tuning the machine learning model based on the natural-language data.
